(19) United States
(12) Patent Application Publication
(10) Pub. No.: US 2012/0105203 A1
(43) Pub. Date: May 3, 2012

(54) SYSTEM AND METHOD FOR PROVIDING PERSONAL ALERTS

(75) Inventors: Jay Elliot, Los Gatos, CA (US); Chris Witte, San Francisco, CA (US); Elisa Miguelena, San Francisco, CA (US)

(73) Assignee: NUVEL, INC., Campbell, CA (US)

(21) Appl. No.: 13/096,924

(22) Filed: Apr. 28, 2011

Related U.S. Application Data
(60) Provisional application No. 61/330,170, filed on Apr. 30, 2010.

(51) Int. Cl. G08B 5/22

(52) U.S. Cl. 340/8.1; 340/6.1

(57) ABSTRACT

Embodiments of the invention are generally related to systems for allowing a person to issue an alert or alarm, and are particularly related to a system and method for providing personal alerts. In accordance with an embodiment, the system comprises a mobile device, such as a cellular telephone or personal digital assistant (PDA) or other device, and/or a software application with a user interface executing on the device. The software application includes a personal 911 or alert icon, which is available to the user as needed. In normal use, a user can configure and enable the device and/or application before an emergency situation occurs, so that it the opportunity to issue an alert available when needed. In an embodiment, the user can do this by depressing/activating and holding an alert icon displayed on the user interface. When released, the user has a short time to disable or cancel the alert. If the alert is not disabled during this time period, the application sends a message, such as a voice or text message, preferably with the users name and position (e.g. longitude and latitude, or other geographic information), estimated current address, and/or any other relevant information such as medical or other information provided by the user during the configuration process, to those contacts previously entered and recorded.

### CLAIM OF PRIORITY

This application claims the benefit of priority to U.S. Provisional Patent Application titled “SYSTEM AND METHOD FOR PROVIDING PERSONAL ALERTS”; Application No. 61/330,170; filed Apr. 30, 2010; which application is herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF INVENTION

Embodiments of the invention are generally related to systems for allowing a person to issue an alert or alarm, and are particularly related to a system and method for providing personal alerts.

### BACKGROUND

A variety of systems exist today for allowing a person to summon help, or otherwise raise an alarm. For example, home-based alarm systems sometimes have a panic button, which the homeowner can press to set off the alarm siren and/or to summon help, say from a police, fire or medial department. Personal systems for use by individuals, particularly by seniors or those who may have a disability or have a potential for falling, can be worn on the person, and can communicate with a base unit in the home. If the person is in difficulty, they can trigger the alarm, which communicates via the base unit with a remote monitoring service. However, a disadvantage of these types of system is that their range of operations is generally restricted to within the person's home, or its immediate surroundings. Many people nowadays have a personal cellular or mobile telephone, which allows them to summon help by calling another person, or, say a police dispatch; and many cellular telephones provide 911 or emergency service that automatically reports the location of the caller to the dispatch, as determined by a GPS feature in the telephone. However, a limitation of calling a 911 service is that it can only be used after an emergency, such as a injury, risk or distress has occurred. These are the general areas that embodiments of the present invention are intended to address.

### SUMMARY

Embodiments of the invention are generally related to systems for allowing a person to issue alert or alarms, and are particularly related to a system and method for providing personal alerts. In accordance with an embodiment, the system comprises a mobile device, such as a cellular telephone or personal digital assistant (PDA) or other device, and/or a software application with a user interface executing on the device. The software application includes a personal 911 or alert icon, which is available to the user as needed. In normal use, a user can configure and enable the device and/or application before an emergency situation occurs, so that it the opportunity to issue an alert available when needed. In an embodiment, the user can do this by depressing/activating and holding an alert icon displayed on the user interface. When released, the user has a short time to disable or cancel the alert. If the alert is not disabled during this time period, the application sends a message, such as a voice or text message, preferably with the users name and position (e.g. longitude and latitude, or other geographic information), estimated current address, and/or any other relevant information such as medical or other information provided by the user during the configuration process, to those contacts previously entered and recorded.

### BRIEF DESCRIPTION OF THE FIGURES

FIG. 1 shows an illustration of a system for providing personal alerts, in accordance with an embodiment.

FIG. 2 shows an illustration of mobility application domain, in accordance with an embodiment.

FIG. 3 shows an illustration of a mobility infrastructure domain, in accordance with an embodiment.

FIG. 4 shows an illustration of a back end services component, in accordance with an embodiment.

FIG. 5 shows a flowchart of a method for providing personal alerts, in accordance with an embodiment.

FIG. 6 shows an illustration of a mobile application for providing personal alerts, in accordance with an embodiment.

### DETAILED DESCRIPTION

As described above, a variety of systems exist today for allowing a person to summon help, or otherwise raise an alarm; for example, home-based alarm systems which have a panic button, personal systems for use by individuals, particularly by seniors or those who may have a disability, and cellular telephones which provide 911 or emergency service. However, a disadvantage of these types of system is that their range of operations is generally restricted to within the person's home, or its immediate surroundings; and/or they are intended for use only after an emergency has occurred.

Embodiments of the invention are generally related to systems for allowing a person to issue an alert or alarm, and are particularly related to a system and method for providing personal alerts. In accordance with an embodiment, the system comprises a mobile device, such as a cellular telephone or personal digital assistant (PDA) or other device, and/or a software application with a user interface executing on the device. The software application includes a personal 911 or alert icon, which is available to the user as needed. The software application is designed to combine a mobile application with an appropriate level of response. In normal use, a user can configure and enable the device and/or application before an emergency situation occurs, so that it the opportunity to issue an alert available when needed.

To configure the device and/or application, the application can be started and the user enter and record contact information, such as the telephone numbers, email address, or messaging information of the person, company or other authority who should be contacted in the case of an emergency. In accordance with an embodiment, the user can launch the application at will to provide an immediate notification to those recorded persons. In an embodiment, the user can do this by depressing/activating and holding an alert icon displayed on the user interface. When released, the user has a short time to disable or cancel the alert. If the alert is not disabled during this time period, the application sends a message, such as a voice or text message, preferably with the users name and position (e.g. longitude and latitude, or other geographic information), estimated current address, and/or any other relevant information such as medical or other information provided by the user during the configuration process, to those contacts previously entered and recorded. In this manner, the application combines the function of a monitored call center, medical team and 911 services, with a portable device such as a smart phone PDA, iPhone blackberry or similar device.

In accordance with various embodiments, the system and/or the application allows a system administrator, or the user themselves to:
Set up an account (referred to herein as an SoS account) which is personal to them and to their needs, on the Web/Internet, or through a mobile or other device;
Set up an alert profile and other preferences which the system will use in the case of an emergency or distress alert;
Broadcast alerts; and
Generally administer the server environment and the configuration information stored therein.

For example, in accordance with an embodiment, a user can register or configure a profile which is personal to them, to specify a number of emergency contacts (e.g., 5), together with those contact's text, email, phone or other messaging or contact information. The registration or configuration information can be stored to, or linked with, a centralized server. In accordance with some embodiments the information can also include any other information which the user desires the system to send in the case of a distress or emergency alert (such as a particular medical need, a note regarding medical history, or similar remarks). When an alert is triggered, the system can notify the contacts, via a messaging gateway, at their text, email, phone or other messaging or contact address. For example, when an alert is issued, the application can send information about the user, such as their location (which can be based on GPS or other means), and the other information the user has configured, to those contacts who have been set up to receive such notification.

In accordance with an embodiment, the application can be architected to pull dynamic data and content from a centralized server and/or distributed servers and profile databases, using web services or similar technology, and can be designed for use on mobile devices such as iPhones, PDAs, smartphones, and similar devices.

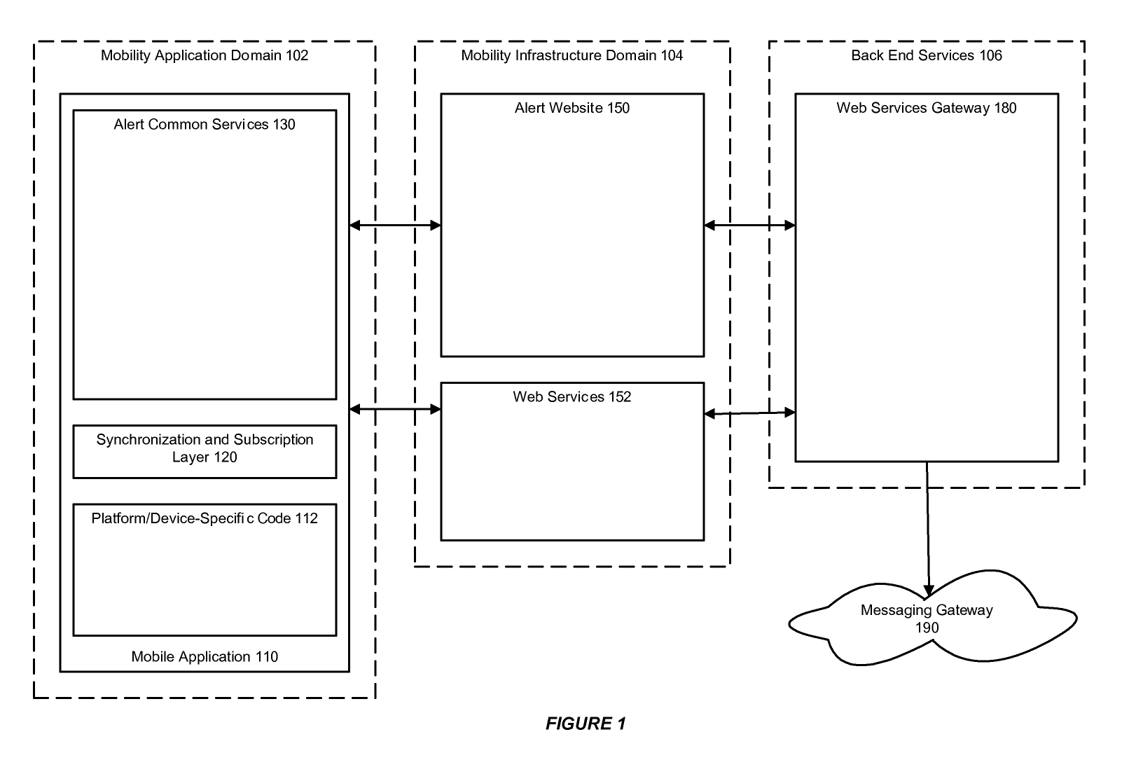

FIG. 1 shows an illustration of a system for providing personal alerts, in accordance with an embodiment. As shown in FIG. 1, in accordance with an embodiment, the system can comprise a mobility application domain 102, mobility infrastructure domain 104, and back end services 104. The mobility application domain includes a mobile application 110, as described above, which mobile application can in turn include any platform or device specific code 122, a synchronization and subscription layer 120, and alert-related common services 130. The mobility infrastructure domain can include one or more alert-related websites 150 and/or web services 152, which pass information communicated to/from the mobility application domain, such as subscription or configuration information, and the back end services. The back end services can include a web services gateway 180 that allows communication with the backend services and/or a messaging gateway 190, and which in turn allows communication with other systems and/or organizations. In accordance with an embodiment, the mobility infrastructure domain, websites, web services, and/or back end services can be centralized and/or distributed over one or more computer systems or networks, such as over one or more computer servers, processors or other computing devices.

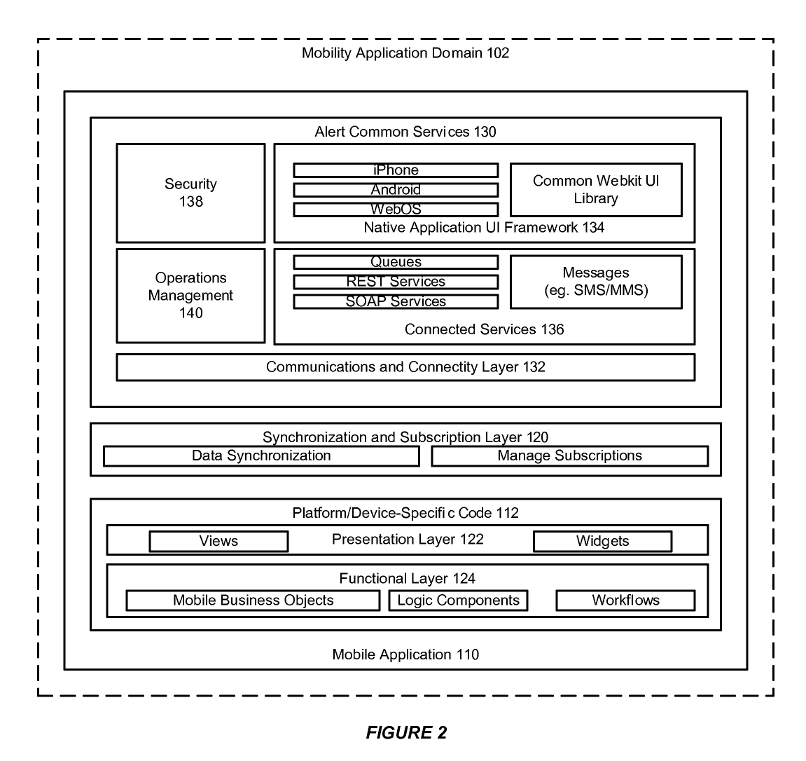

FIG. 2 shows an illustration of a mobility application domain, in accordance with an embodiment. As shown in FIG. 2, in accordance with an embodiment, the mobility application can include a plurality of components, depending on the particular desired implementation. In the particular example shown in FIG. 2, the mobility application can include the platform or device specific code described above, which in an embodiment further includes a functional layer 124 and a presentation layer 122; the synchronization and subscription layer, which in an embodiment further includes a data synchronization component and a subscription management component; and the alert-related common services, which in an embodiment further includes a communication and connectivity layer 132, microsite/native application UI framework 134, connected services 136, security 138, and operations management 140 components. These allow the mobile application to work with a variety of different connected services, such as REST and SOAP, and a variety of different mobile devices, such as iPhone or Android. It will be evident to one of ordinary skill in the art that additional and/or other components can be used in accordance with other embodiments and for other implementations.

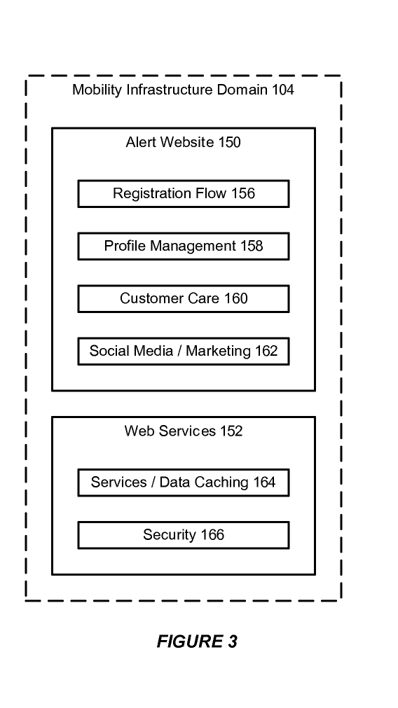

FIG. 3 shows an illustration of a mobility infrastructure domain, in accordance with an embodiment. As shown in FIG. 3, in accordance with an embodiment, the mobility infrastructure domain can include one or more alert-related websites, which in an embodiment further include registration flow 156, profile management 158, customer care, 160 and social media/marketing 162 components; and/or web services, which in an embodiment further include data caching and other services 164 and security 166 components. Again, it will be evident to one of ordinary skill in the art that additional and/or other components can be used in accordance with other embodiments and for other implementations.

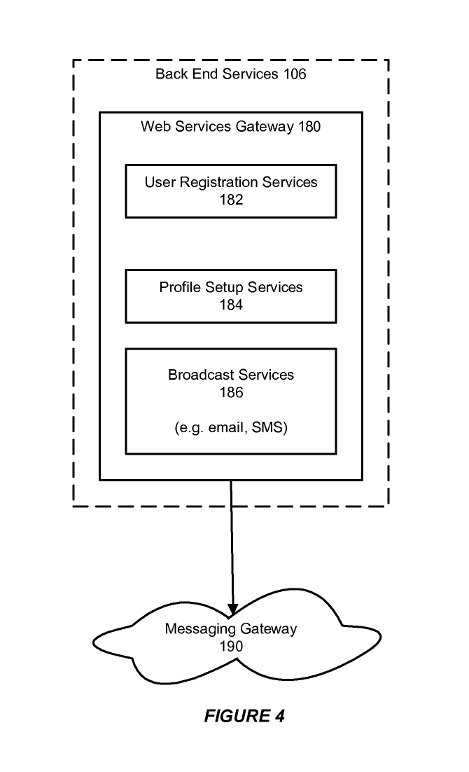

FIG. 4 shows an illustration of a back end services component, in accordance with an embodiment. As shown in FIG. 4, the back end services can include a web services gateway, which in an embodiment further includes user registration services 182, profile setup services 184, and broadcast services 186 (e.g. email, SMS, or another messaging paradigm). Again, it will be evident to one of ordinary skill in the art that additional and/or other components can be used in accordance with other embodiments and for other implementations. In accordance with an embodiment, the back end services can stored registered or configured user profiles, such as emergency contacts' text, email, phone or other messaging or contact information, and/or any other information which the user desires the system to send in the case of a distress or emergency alert (such as a particular medical need, a note regarding medical history, or similar remarks).

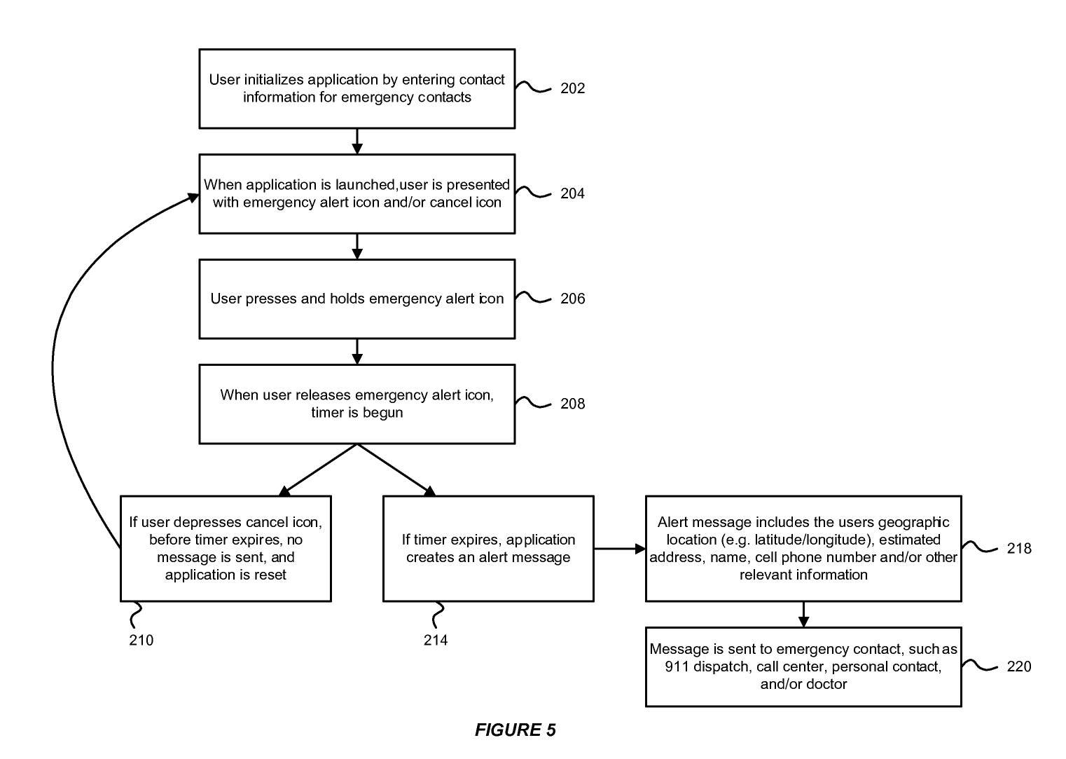

FIG. 5 shows a flowchart of a method for providing personal alerts, in accordance with an embodiment. As shown in FIG. 5, in step 202, the user initializes the application by entering contact information for emergency contacts, etc. In step 204, when application is launched, the user is presented with an emergency alert icon and/or a cancel icon. In step 206, in case of an emergency or distress, the user presses and holds the emergency alert icon. In step 208, when the user releases the emergency alert icon, a timer is begun. In accordance with an embodiment the appearance of the emergency alert icon can change to become the cancel icon. In step 210, if the user depresses the cancel icon, before the timer expires, then no message is sent, and the application is reset. In step 214, if the timer expires, then the application creates an alert message. In step 216, the alert message is created or modified so that it includes the users geographic location (e.g. latitude/longitude), estimated address, name, cell phone number and/or other relevant information. In step 220, an alert message is sent to an emergency contact, such as 911 dispatch, call center, personal contact, and/or doctor, as entered and recorded by the user during the configuration process.

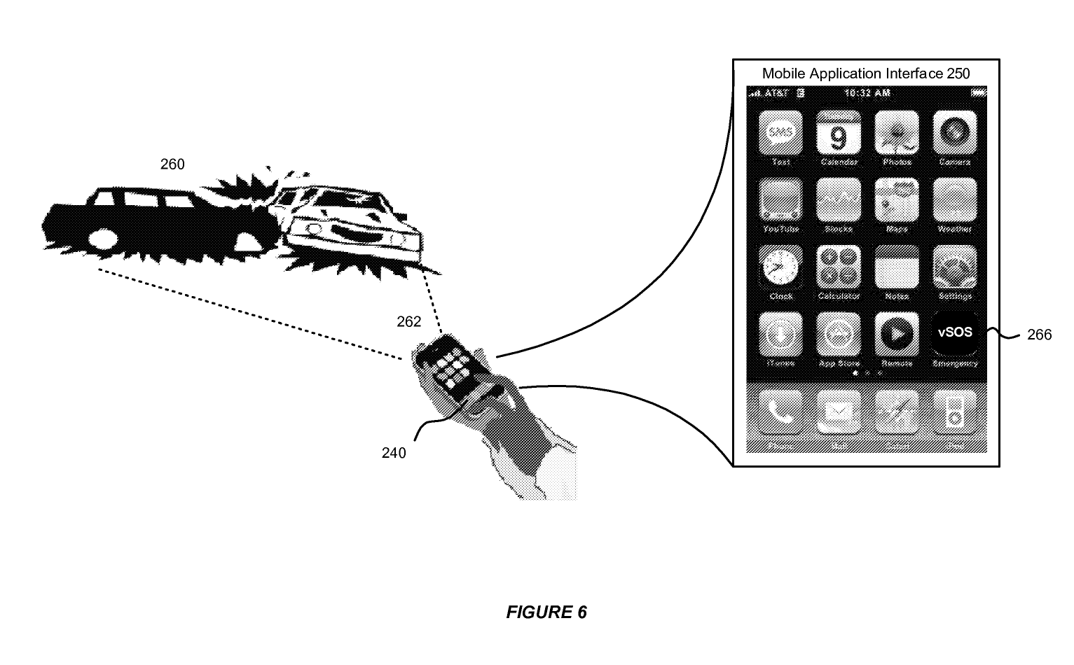

FIG. 6 shows an illustration of a mobile application for providing personal alerts, in accordance with an embodiment. As shown in FIG. 6, in accordance with an embodiment, a mobile device, such as a in the case of an emergency or distress, such as a cellular telephone or PDA 240 can be equipped with the mobile application as described above, which includes the mobile application interface 250 and the alert icon 266, in this instance displayed as a “vSOS” icon. In the event of an emergency, distress or other alarm situation, such as a medical emergency or in this example an automobile accident 260, the user can trigger the alert in a manner similar to that described above, to send an alert message to an emergency contact, such as 911 dispatch, call center, personal contact, and/or doctor, as entered and recorded by the user during the configuration process.

In accordance with an embodiment, the system can also be designed so that it will take, record and/or communicate pictures, video, or other information 262, of the scene, as part of the alert message. For example, a camera-equipped mobile device/application can include pictures of the user and/or their surroundings or an emergency scene, which can provide useful additional information for first responders.

The present invention may be conveniently implemented using one or more conventional general purpose or specialized digital computers or microprocessors programmed according to the teachings of the present disclosure. Appropriate software coding can readily be prepared by skilled programmers based on the teachings of the present disclosure, as will be apparent to those skilled in the software art.

In some embodiments, the present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

The foregoing description of the present invention has been provided for the purposes of illustration and description. It is not intended to be exhaustive or to limit the invention to the precise forms disclosed. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A system for providing personal alerts, comprising:
a mobility application domain that includes an application which the user can initialize by entering a contact information for emergency contacts and/or other profile or configuration information, and wherein the application, in case of an emergency or distress, allows the user to trigger an alert;
one or more back end services that allow communication of the contact information and/or other profile or configuration information via messaging with other systems and/or organizations; and
an interface to a mobility infrastructure domain that includes one or more alert-related websites and/or web services and that receives information from the mobility application domain, such as the contact information for emergency contacts and/or other profile or configuration information, and communicates that information to the back end services for use in communicating triggered alerts.

2. The system of claim 1, wherein the user can configure and enable the application before an emergency or distress situation occurs, so that the opportunity to trigger an alert is available when needed.

3. The system of claim 1, wherein the application is provided on a mobile device.

4. The system of claim 1, wherein the application is configured so that it includes a user interface and an alert icon, and wherein the user can trigger the alert by depressing, holding, or otherwise activating the alert icon.

5. The system of claim 4, wherein when the alert icon is released or otherwise activated, the user is provided with a time period within which to disable the alert, and wherein if the alert is not disabled during the time period, the application automatically sends an alert message with the user's identification, position, and/or any other relevant information provided by the user during the configuration process, to the emergency contacts.

6. The system of claim 5, wherein the alert message is sent to one or more of a 911 dispatch service, call center, personal contact, and/or doctor, as entered and recorded by the user during configuration of the application.

7. A method for providing a personal alert system, comprising the steps of:
providing a mobility application domain that includes an application which the user can initialize by entering a contact information for emergency contacts and/or other profile or configuration information, and wherein the application, in case of an emergency or distress, allows the user to trigger an alert;
providing one or more back end services that allow communication of the contact information and/or other profile or configuration information via messaging with other systems and/or organizations; and
providing an interface to a mobility infrastructure domain that includes one or more alert-related websites and/or web services and that receives information from the mobility application domain, such as the contact information for emergency contacts and/or other profile or configuration information, and communicates that information to the back end services for use in communicating triggered alerts.

8. The method of claim 7, wherein the user can configure and enable the application before an emergency or distress situation occurs, so that the opportunity to trigger an alert is available when needed.

9. The method of claim 7, wherein the application is provided on a mobile device.

10. The method of claim 7, wherein the application is configured so that it includes a user interface and an alert icon, and wherein the user can trigger the alert by depressing, holding, or otherwise activating the alert icon.

11. The method of claim 10, wherein when the alert icon is released or otherwise activated, the user is provided with a time period within which to disable the alert, and wherein if the alert is not disabled during the time period, the application automatically sends an alert message with the user's identification, position, and/or any other relevant information provided by the user during the configuration process, to the emergency contacts.

12. The method of claim 11, wherein the alert message is sent to one or more of a 911 dispatch service, call center, personal contact, and/or doctor, as entered and recorded by the user during configuration of the application.

13. A computer readable medium including instructions stored thereon, which when read and executed by one or more computers cause the computer to perform the steps comprising:
providing a mobility application domain that includes an application which the user can initialize by entering a contact information for emergency contacts and/or other profile or configuration information, and wherein the application, in case of an emergency or distress, allows the user to trigger an alert;
providing one or more back end services that allow communication of the contact information and/or other profile or configuration information via messaging with other systems and/or organizations; and
providing an interface to a mobility infrastructure domain that includes one or more alert-related websites and/or web services and that receives information from the mobility application domain, such as the contact information for emergency contacts and/or other profile or configuration information, and communicates that information to the back end services for use in communicating triggered alerts.

14. The computer readable medium of claim 13, wherein the user can configure and enable the application before an emergency or distress situation occurs, so that the opportunity to trigger an alert is available when needed.

15. The computer readable medium of claim 13, wherein the application is provided on a mobile device.

16. The computer readable medium of claim 13, wherein the application is configured so that it includes a user interface and an alert icon, and wherein the user can trigger the alert by depressing, holding, or otherwise activating the alert icon.

17. The computer readable medium of claim 16, wherein when the alert icon is released or otherwise activated, the user is provided with a time period within which to disable the alert, and wherein if the alert is not disabled during the time period, the application automatically sends an alert message with the user's identification, position, and/or any other relevant information provided by the user during the configuration process, to the emergency contacts.

18. The computer readable medium of claim 17, wherein the alert message is sent to one or more of a 911 dispatch service, call center, personal contact, and/or doctor, as entered and recorded by the user during configuration of the application.
